(19) United States
(12) Patent Application Publication
(10) Pub. No.: US 2025/0110517 A1
(43) Pub. Date: Apr. 3, 2025

(54) VOLTAGE REGULATOR

(71) Applicant: ABLIC Inc., Nagano (JP)

(72) Inventor: Kaoru SAKAGUCHI, Nagano (JP)

(73) Assignee: ABLIC Inc., Nagano (JP)

(21) Appl. No.: 18/772,235

(22) Filed: Jul. 14, 2024

(30) Foreign Application Priority Data
Sep. 29, 2023 (JP) 2023-169214

(51) Int. Cl. G05F 1/569; G05F 1/575; G05F 3/26

(52) U.S. Cl. CPC G05F 1/569; G05F 1/575; G05F 3/262

(57) ABSTRACT

A voltage regulator includes an output transistor which outputs an output voltage to an output port; a dividing resistor which divides an adjustment voltage input to a voltage adjustment port and outputs a feedback voltage; a first reference voltage circuit which outputs a first reference voltage; an error amplifier circuit which controls a gate voltage of the output transistor based on the first reference voltage and the feedback voltage; and a ground fault protection circuit which, upon monitoring the adjustment voltage and detecting the voltage adjustment port having a ground fault, increases the feedback voltage to the first reference voltage.

### CROSS-REFERENCE TO RELATED APPLICATIONS

This application claims the priority benefits of Japanese application no. 2023-169214, filed on Sep. 29, 2023. The entity of the above-mentioned patent application is hereby incorporated by reference herein and made a part of this specification.

### BACKGROUND

### Technical Field

The present invention relates to a voltage regulator.

### Related Art

In general, a voltage regulator generates a constant voltage from a power supply voltage input to an input port, outputs a constant voltage to an output port, and maintains the output voltage at a constant value even if the power supply voltage or load current fluctuates. Moreover, it includes an overcurrent protection circuit for controlling an output transistor to turn off in the case where an excessive current flows through the output port, for example, in the case where the output port has a ground fault.

### SUMMARY

### Technical Problem

However, in the case where a voltage adjustment port for adjusting the output voltage is provided separately from the output port, in the overcurrent protection circuit of a conventional voltage regulator, it is difficult to suppress an excessive voltage from occurring at the output port in the case where a dividing resistor connected to a voltage adjustment port has a ground fault.

The present invention provides a voltage regulator capable of suppressing an excessive voltage from occurring at an output port in the case where a voltage adjustment port has a ground fault.

### Solution to Problem

A voltage regulator in accordance with an embodiment of the present invention includes: an output transistor which outputs an output voltage to an output port; a dividing resistor which divides an adjustment voltage input to a voltage adjustment port and outputs a feedback voltage; a first reference voltage circuit which outputs a first reference voltage; an error amplifier circuit which controls a gate voltage of the output transistor based on the first reference voltage and the feedback voltage; and a ground fault protection circuit which, upon monitoring the adjustment voltage and detecting the voltage adjustment port having a ground fault, increases the feedback voltage to the first reference voltage.

### Effects

According to the present invention, a voltage regulator can be provided, which includes a ground fault protection circuit which, upon monitoring the adjustment voltage and detecting the voltage adjustment port having a ground fault, increases the feedback voltage to the first reference voltage, thereby suppressing an excessive voltage from occurring at an output port in the case where a voltage adjustment port has a ground fault.

### BRIEF DESCRIPTION OF THE DRAWINGS

FIG. 1 is a circuit diagram illustrating an example of a voltage regulator according to an embodiment of the present invention.

FIG. 2 is a circuit diagram illustrating an example of a ground fault protection circuit according to the embodiment.

FIG. 3 is a circuit diagram illustrating another example of the ground fault protection circuit according to the embodiment.

FIG. 4 is a circuit diagram illustrating yet another example of the ground fault protection circuit according to the embodiment.

FIG. 5 is a circuit diagram illustrating still another example of the ground fault protection circuit according to the embodiment.

### DESCRIPTION OF THE EMBODIMENTS

Voltage regulators according to the embodiments of the present invention will now be described with reference to the drawings.

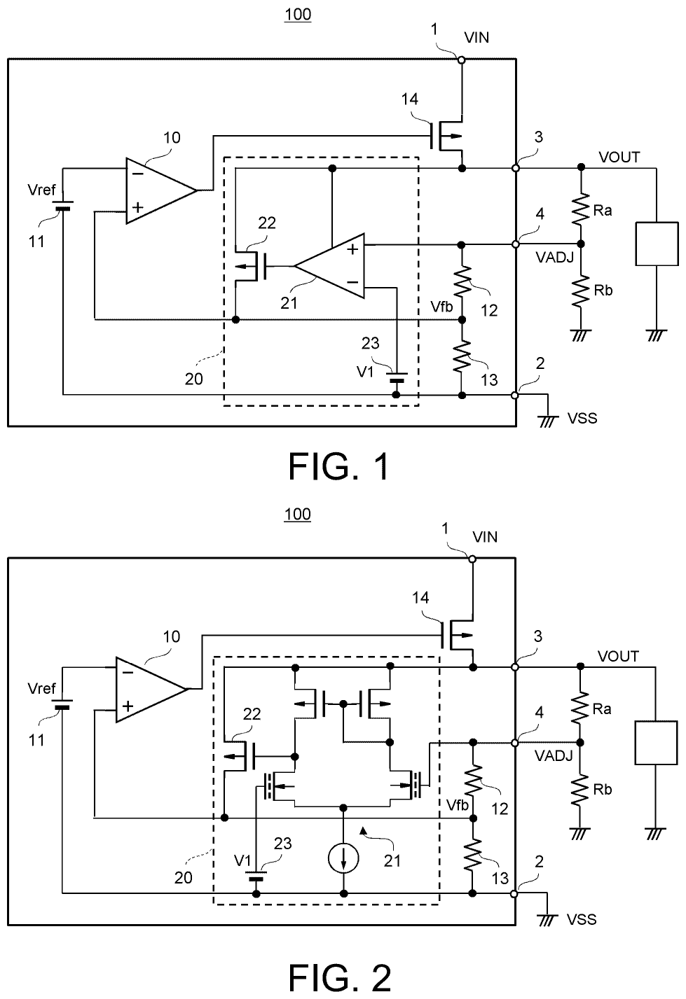

FIG. 1 is a circuit diagram of a voltage regulator 100 which is an example of a voltage regulator according to an embodiment of the present invention.

The voltage regulator 100 includes an input port 1, a ground port 2, an output port 3, a voltage adjustment port 4, an error amplifier circuit 10, a reference voltage circuit 11, resistors 12 and 13 which are dividing resistors, an output transistor 14, and a ground fault protection circuit 20.

The ground fault protection circuit 20 includes a comparison circuit 21, a PMOS transistor 22, and a reference voltage circuit 23.

The output transistor 14 includes a source connected to the input port 1, a drain connected to the output port 3, and a gate connected to an output port of the error amplifier circuit 10. The error amplifier circuit 10 includes an inverting input port − connected to an output port of the reference voltage circuit 11, and a non-inverting input port + connected to the connection point between the resistor 12 and the resistor 13. The resistor 12 and the resistor 13 are connected in series between the voltage adjustment port 4 and the ground port 2.

The ground fault protection circuit 20 is connected as follows.

The comparison circuit 21 includes a power supply port connected to the output port 3, a non-inverting input port + connected to the voltage adjustment port 4, an inverting input port − connected to an output port of the reference voltage circuit 23, and an output port connected to a gate of the PMOS transistor 22. The PMOS transistor 22 includes a source connected to the output port 3 and a drain connected to a non-inverting input port + of the error amplifier circuit 10.

The voltage adjustment port 4 is connected to a connection point between a resistor Ra and a resistor Rb, which are dividing resistors. In other words, the voltage regulator 100 may arbitrarily adjust an output voltage VOUT using the external resistors Ra and Rb. A load LD is connected to the output port 3.

The operation of the voltage regulator 100 will now be described.

The voltage regulator 100 generates a constant voltage from a voltage VIN input to the input port 1 and outputs it as the output voltage VOUT from the output port 3. The resistor 12 and the resistor 13 generate a feedback voltage Vfb from an adjustment voltage VADJ input from the voltage adjustment port 4. The error amplifier circuit 10 controls a gate voltage of the output transistor 14 based on a reference voltage Vref output by the reference voltage circuit 11 and the feedback voltage Vfb. In other words, the output voltage VOUT of the voltage regulator 100 is controlled to a voltage at which the feedback voltage Vfb is equal to the reference voltage Vref.

In the case where the voltage adjustment port 4 has a ground fault for some reason, the adjustment voltage VADJ, that is, the feedback voltage Vfb drops to the voltage of the ground port 2. In the case where the feedback voltage Vfb drops and becomes lower than the reference voltage Vref, the error amplifier circuit 10 lowers the output voltage. Thus, the gate voltage of the output transistor 14 drops, and the output voltage VOUT of the voltage regulator 100 becomes higher than the desired voltage. At this time, since the resistor Ra is connected to the output port 3, no overcurrent flows through the output port 3. In other words, even if an overcurrent protection circuit is provided, the increase in the output voltage VOUT cannot be suppressed.

Next, the operation of the ground fault protection circuit 20 in the case where the voltage adjustment port 4 has a ground fault will be described.

In the case where the voltage adjustment port 4 has a ground fault, the adjustment voltage VADJ and the feedback voltage Vfb drop to the voltage of the ground port 2. The error amplifier circuit 10 controls to lower the gate voltage of the output transistor 14 to increase the output voltage VOUT.

In the comparison circuit 21, in the case where the adjustment voltage VADJ input to the non-inverting input port + falls below a reference voltage V1 of the reference voltage circuit 23 input to the inverting input port −, the voltage at the output port drops. The PMOS transistor 22 turns on as the gate voltage decreases. Since the source of the PMOS transistor 22 is connected to the output port 3, the feedback voltage Vfb increases.

Thus, in the case where the feedback voltage Vfb input to the non-inverting input port + rises and becomes higher than the reference voltage Vref input to the inverting input port −, the error amplifier circuit 10 controls to increase the gate voltage of the output transistor 14 to lower the output voltage VOUT.

At this time, the feedback voltage Vfb is generated by the current of the PMOS transistor 22 flowing through the resistor 12 and the resistor 13 connected in parallel. Thus, the output voltage VOUT stabilizes at a voltage lower than the desired voltage, where the feedback voltage Vfb is equal to the reference voltage Vref. In this manner, in the case where the voltage adjustment port 4 has a ground fault, the ground fault protection circuit 20 suppresses the output voltage VOUT from becoming higher than a desired voltage.

Furthermore, the ground fault protection circuit 20 does not interfere with the operation of the voltage regulator 100 during normal operation.

First, before the voltage regulator 100 starts up, the output voltage VOUT and the adjustment voltage VADJ are both low voltages. The PMOS transistor 22 will not turn on because its source is the output voltage VOUT.

Next, in the case where the voltage regulator 100 starts up, the PMOS transistor 22 is not turned on since the adjustment voltage VADJ also rises together with the rise in the output voltage VOUT.

FIG. 2 is a circuit diagram illustrating an example of the ground fault protection circuit 20 of the embodiment.

In the ground fault protection circuit 20 of FIG. 2, the comparison circuit 21 is a comparator including two PMOS transistors, two NMOS transistors, and a current source. Since the reference voltage V1 for detecting a ground fault at the voltage adjustment port 4 is set to a low voltage, it is desirable that the two NMOS transistors be configured as depletion type. In the ground fault protection circuit 20, the PMOS transistor 22 is on/off controlled i.e., switch-operated, by the comparator.

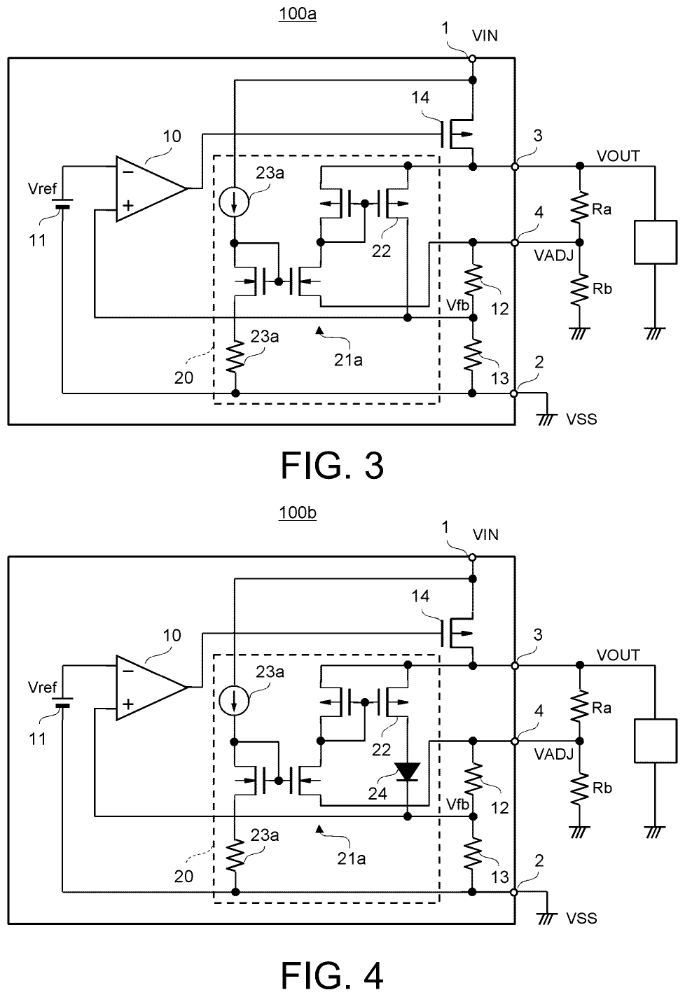

FIG. 3 is a circuit diagram illustrating another example of the ground fault protection circuit 20 of the embodiment.

In the ground fault protection circuit 20 of FIG. 3, a comparison circuit 21a is composed of a PMOS transistor and two NMOS transistors, and a reference voltage circuit 23a is composed of a constant current source and a resistor. The reference voltage circuit 23a generates the reference voltage V1 at the resistor. The PMOS transistor of the comparison circuit 21a forms a current mirror circuit with the PMOS transistor 22. Thus, in the case where the PMOS transistor 22 is turned on, a current corresponding to the current of the PMOS transistor flows, thereby increasing the feedback voltage Vfb.

FIG. 4 is a circuit diagram illustrating yet another example of the ground fault protection circuit 20 of the embodiment.

The ground fault protection circuit 20 of FIG. 4 includes a diode 24, which is a backflow prevention element, at the drain of the PMOS transistor 22 in the ground fault protection circuit 20 of FIG. 3. The diode 24 includes an anode connected to the drain of the PMOS transistor 22 and a cathode connected to the non-inverting input port + of the error amplifier circuit 10.

The diode 24 is effective in preventing current from flowing from the connection point between the resistor 12 and the resistor 13 to the output port 3 through the parasitic diode of the PMOS transistor 22.

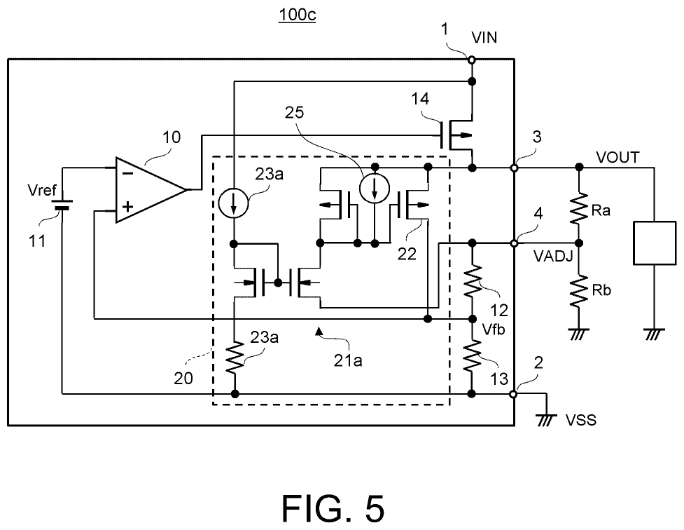

FIG. 5 is a circuit diagram illustrating still another example of the ground fault protection circuit 20 of the embodiment.

The ground fault protection circuit 20 of FIG. 5 includes a current source 25, which is a pull-up element, between the output port 3 and the gate of the PMOS transistor 22 in the ground fault protection circuit 20 of FIG. 3.

The current source 25 is effective in preventing the leakage current of the PMOS transistor 22 from flowing to the connection point between the resistor 12 and the resistor 13 during normal operation.

As described above, according to the voltage regulator 100 of the present embodiment, the voltage adjustment port 4 includes the ground fault protection circuit 20, thus even if the voltage adjustment port 4 has a ground fault, the generation of an excessive voltage at the output port 3 of the voltage regulator 100 can be suppressed.

The present invention is not limited to the above-described embodiment, but may be embodied in various forms. Furthermore, various omissions, additions, substitutions, or modifications may be made without departing from the spirit of the present invention. These embodiments and their variations are included in the scope and spirit of the present invention, and are included in the scope of the present invention and its equivalents described in the claims.

What is claimed is:

1. A voltage regulator, comprising:
an output transistor which outputs an output voltage to an output port;
a dividing resistor which divides an adjustment voltage input to a voltage adjustment port and outputs a feedback voltage;
a first reference voltage circuit which outputs a first reference voltage;
an error amplifier circuit which controls a gate voltage of the output transistor based on the first reference voltage and the feedback voltage; and
a ground fault protection circuit which, upon monitoring the adjustment voltage detecting the voltage adjustment port having a ground fault, increases the feedback voltage to the first reference voltage.

2. The voltage regulator according to claim 1,
wherein the ground fault protection circuit comprises:
a comparison circuit which compares the adjustment voltage and a second reference voltage; and
a first MOS transistor having a source connected to an output port, a drain connected to an output port of the dividing resistor, and a gate connected to an output port of the comparison circuit.

3. The voltage regulator according to claim 2,
wherein the comparison circuit is composed of a comparator.

4. The voltage regulator according to claim 1, comprising:
wherein the ground fault protection circuit comprises:
a second reference voltage circuit comprising a current source and a resistor connected in series between an input port and a ground port;
a comparison circuit which comprises: a second MOS transistor provided between the current source and the resistor and having a gate connected to a drain; a third MOS transistor having a gate connected to the gate of the second MOS transistor; and a fourth MOS transistor having a gate and a drain connected to a drain of the third MOS transistor, and which compares the adjustment voltage and the second reference voltage, and
a first MOS transistor having a source connected to an output port, a drain connected to an output port of the dividing resistor, and a gate connected to the gate of the fourth MOS transistor of the comparison circuit.

5. The voltage regulator according to claim 4,
wherein the ground fault protection circuit comprises:
a backflow prevention element at the drain of the first MOS transistor.

6. The voltage regulator according to claim 4,
wherein the ground fault protection circuit comprises:
a pull-up element on the gate of the first MOS transistor.

7. The voltage regulator according to claim 5,
wherein the ground fault protection circuit comprises:
a pull-up element on the gate of the first MOS transistor.
